(19) United States
(12) Patent Application Publication
(10) Pub. No.: US 2025/0086435 A1
(43) Pub. Date: Mar. 13, 2025

(54) ANOMALY DETECTION AND USER ATTRIBUTION USING MACHINE-LEARNING LARGE LANGUAGE MODELS

(71) Applicant: Maplebear Inc., San Francisco, CA (US)

(72) Inventors: Benjamin Knight, Oakland, CA (US); Kenneth Jason Sanchez, Orange, CA (US); Christopher Billman, Chicago, IL (US); Rebecca Riso, Croton-On-Hudson, NY (US); Matthew Negrin, Brooklyn, NY (US); Licheng Yin, Mississauga (CA)

(21) Appl. No.: 18/885,294

(22) Filed: Sep. 13, 2024

Related U.S. Application Data
(60) Provisional application No. 63/538,253, filed on Sep. 13, 2023.

(51) Int. Cl. G06N 3/0455; G06N 3/09; G06Q 10/087

(52) U.S. Cl. CPC G06N 3/0455; G06N 3/09; G06Q 10/087

(57) ABSTRACT

An online system detects an anomaly associated with an item selection made by a picker for fulfilling an order of a user of an online system. The system generates a prompt for execution by a machine-learned model trained as a large language model. The prompt comprises a chat log between the picker and the user. The system provides the prompt to the machine-learned model for execution. The system receives, as output from the machine-learned model and based on the chat log, a description indicating whether the anomaly is attributable to the user. The system determines, based on the output from the machine-learned model, that the item selection is not attributable to the user. Responsive to determining that the item selection is not attributable to the user, the system provides a notification to a client device of the user to confirm whether the item selection is approved by the user.

### CROSS-REFERENCE TO RELATED APPLICATIONS

This application claims the benefit of U.S. Provisional Patent Application No. 63/538,253, filed on Sep. 13, 2023, which is incorporated by reference herein in its entirety.

### BACKGROUND

An online system connects users to pickers for fulfilling the user's order. During the fulfillment, there may be times in which a picker needs to make adjustments to the order based on the item inventories on the shelves. There is a balance between keeping strict rules about how much a shopper can deviate from the user's intended order and allowing a picker's best judgment. Without guardrails, a picker may add items or qualities beyond what the user wants in a way that may cause appeasement issues later. However, preventing the picker from making needed adjustments may cause user dissatisfaction as well.

SUMMARY

In one or more embodiments, techniques related to analyzing the nature of the interactions between the user and picker to determine whether the picker's behavior matches the expectations of the customer are presented. A method having a plurality of steps may include a step of detecting an anomaly associated with an item selection made by a shopper for fulfilling an order of a user of an online system. The steps further include a step of generating a prompt for execution by a machine-learned model trained as a large language model on a large corpus of training data to perform natural language processing tasks, the prompt comprising at least a chat log between the picker and the user. The steps further include a step of providing the prompt to the machine-learned model for execution. The steps further include a step of receiving, as output from the machine-learned model and based on at least the chat log, a description indicating whether the anomaly is attributable to the user. The steps further include a step of determining, based on the output from the machine-learned model, that the item selection is not attributable to the user. The steps further include a step of responsive to determining that the item selection is not attributable to the user, providing a notification to a client device of the user to confirm whether the item selection is approved by the user. The steps further include a step of providing another notification to a client device of the shopper indicating that payment for the item selection is on hold pending approval of the user.

### BRIEF DESCRIPTION OF THE DRAWINGS

FIG. 1A illustrates an example system environment for an online system, in accordance with one or more embodiments.

FIG. 1B illustrates an example system environment for an online system, in accordance

with one or more embodiments.

FIG. 2 illustrates an example system architecture for an online system, in accordance with one or more embodiments.

FIG. 3 illustrates a block diagram of a workflow guardrails module of an online system, in accordance with one or more embodiments.

FIG. 4A illustrates an example notification to a client device of a user of an online system, in accordance with one or more embodiments.

FIG. 4B illustrates an example notification to a client device of a shopper of an online system, in accordance with one or more embodiments.

FIG. 5 is a flowchart of a method for modifying workflow guardrails for order fulfillment on an online system, in accordance with one or more embodiments.

### DETAILED DESCRIPTION

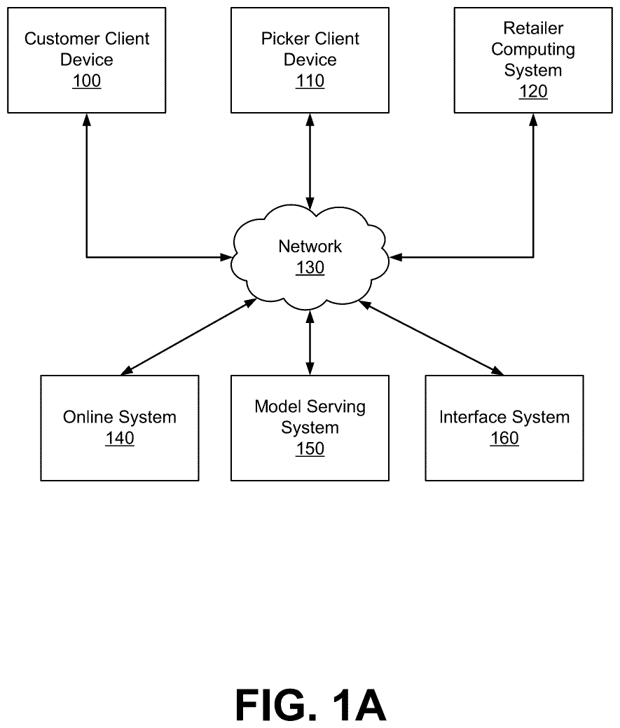

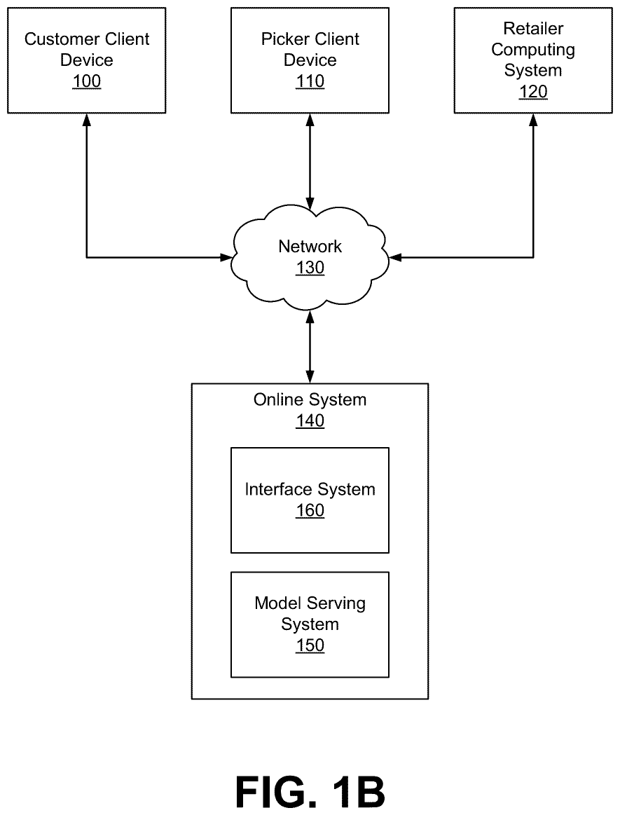

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In one or more embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In one or more embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In one or more embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In one or more embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In one or more embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In one or more embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In one or more embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In one or more embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order.

Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in one or more embodiments, some or all of the steps taken by the picker may be automated. For example, a semi-or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In one or more embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provide portions of the payment from the customer to the picker and the retailer.

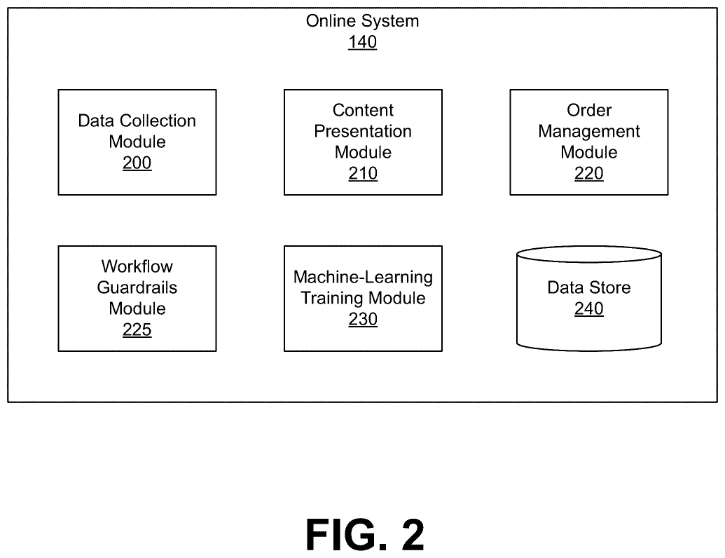

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online system 140 guides order fulfillment by a shopper (e.g., picker) based on customer messages. Specifically, the online system 140 prepares a prompt for input to the model serving system 150, the prompt requesting a review of customer messages (e.g., chat log) by a machine-learned model trained on message logs of communication between users and shoppers. The online system 140 receives a response to the prompt from the model serving system 150 based on execution of the machine-learned model using the prompt. The online system 140 analyzes the response and determines whether an anomaly detected in item selection by the shopper for fulfilling the user's order is attributable to the user. For example, if the original order for a user did not include organic red grapes but the shopper picks this item (e.g., by scanning a barcode using the client device of the shopper while picking items from grocery store shelves and placing the items in a shopping cart), the online system 140 utilizes the machine-learned model to analyze the chat history between the user and the shopper to determine whether the user instructed the shopper to add the organic red grapes to the order. Based on the determination, the online system 140 considers whether an affirmative approval from the user for the item selection is needed. In the above example, if it is clear from the chat log that the user asked the shopper to add the organic red grapes to the order, the online system 140 may determine an explicit approval is not needed. On the other hand, if the chat history does not include any discussion of adding organic red grapes to the order, the online system 140 may trigger additional verification and validation workflows by, e.g., transmitting a push notification to the user's device prompting the user to explicitly approve or reject addition of this anomalous item selection to the order. In one or more embodiments, the online system 140 may also transmit a push notification to a client device of the shopper indicating that the item selection is on hold pending approval from the user.

A shopper fulfilling an order may need to modify the order of the user if, for example, certain items are out-of-stock at the retailer. Moreover, the shopper may discuss various aspects of the order with the user in a chat interface of the online system 140 to, for example, agree to potential replacement items, make quantity or weight modifications, add additional items, and the like. While this allows orders to be flexibly modified and increase customer and shopper satisfaction, in some cases, barriers have to be established in case modifications to the order are improper. Thus, the online system 140 needs to strike a balance between introducing barriers into the picking or shopping application workflow (for example, blocking the shopper from adding items not included in the order, or adding quantities far beyond what the customer ordered) versus leaving the shopper free to use his or her best judgment in the context of replacing an item or adding an item or modifying item quantity or weight. Informing this tradeoff can be difficult. Non-machine-readable shopper and user messages (e.g., natural language chat history), and other data (e.g., historical order data, chat history data, replacement data, product data, and the like) may be valuable in informing this tradeoff.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with one or more embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In one or more embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In one or more embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In one or more embodiments, the item selection model uses item embeddings describing items and customer embeddings describing customers to score items. These item embeddings and customer embeddings may be generated by separate machine learning models and may be stored in the data store 240.

In one or more embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In one or more embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In one or more embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In one or more embodiments, the order management module 220 receives images of items from the picker client device 110 and applies computer-vision techniques to the images to identify the items depicted by the images.

The order management module 220 may track the progress of the picker as the picker collects items for an order and may transmit progress updates to the customer client device 100 that describe which items have been collected for the customer's order.

In one or more embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In one or more embodiments, the order management module 220 computes an estimated time of arrival for the picker at the delivery location and provides the estimated time of arrival to the customer.

In one or more embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In one or more embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The workflow guardrails module 225 detects one or more changes to an order of a user by the shopper (e.g., picker) that may be potential anomalies. The workflow guardrails module 225 determines whether the anomaly is attributable to the user who placed the order (e.g., because user asked in a chat message to add an item to the order, approve a replacement, modify quantity or weight of an item, and the like) based on an analysis of the chat history between the user and the shopper. More generally, the workflow guardrails module 225 uses machine-learned models to determine whether the change to the order and the corresponding item selection is an order modification that may be acceptable to the user (e.g., based on chat messages, the user's past shopping history, historical data of all orders that include the item corresponding to the anomaly, associated replacement history data, and the like).

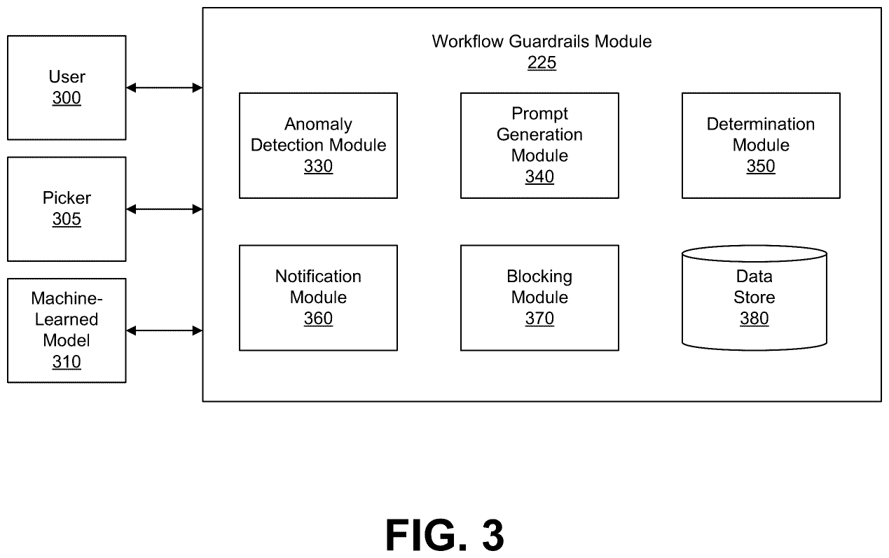

Based on the output from the model, the workflow guardrails module 225 may inform the level of scrutiny to be applied for the detected anomaly. The level of scrutiny may range from no action (i.e., allowing the shopper to continue to checkout and deliver the order with the detected changes), to triggering one or more notifications (e.g., prompting the user to explicitly approve the change before the shopper can checkout and deliver the order or otherwise receive payment for the changed portion of the order) via an application, to blocking the shopper's item selection (e.g., preventing the shopper from proceeding further in the checkout workflow during order fulfillment without modifying or undoing the changes made to the order by reducing item quantity, removing an item from the cart, and the like). Details of the workflow guardrails module 225 are described below in connection with FIGS. 3-5.

The machine learning training module 230 trains machine learning models used by the online system 140. For example, the machine learning module 230 may train the item selection model, the availability model, chat history analysis model, order estimation model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering.

The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

FIG. 3 illustrates a block diagram of the workflow guardrails module 225 of FIG. 2, in accordance with one or more embodiments. As shown in FIG. 3, the workflow guardrails module 225 includes an anomaly detection module 330, a prompt generation module 340, a determination module 350, a notification module 360, a blocking module 370, and a data store 380. Alternative embodiments may include more, fewer, or different components from those illustrated in FIG. 3, and the functionality of each component may be divided between the components differently from the description below. Additionally, each component may perform their respective functionalities in response to a request from a human, or automatically without human intervention.

The anomaly detection module 330 may detect an anomaly associated with an item selection made by a shopper (e.g., picker) 305 for fulfilling an order of a user 300 of an online system (e.g., online system 140). As the items selected by the shopper 305 diverge from the item originally selected by the customer 300, the anomaly detection module 330 detects a potential anomaly associated with the selection. In one or more embodiments, the anomaly may be related to a weight or quantity discrepancy.

The online system may receive an order for delivery of one or more products (e.g., specific SKUs, and associated quantities, weights, and the like) from the user 300. The online system may offer the order for fulfillment to the shopper 305 who may accept the order and begin working on fulfilling the order. During the order fulfillment process, the shopper 305 may visit the retail location (e.g., grocery store) from where the user 300 has ordered items and the shopper 305 may begin shopping for items from the retailer for the order.

As explained previously, the online system may offer a communication interface respectively accessible via the client devices of the user 300 and the shopper 305 to enable communication between the user 300 and the shopper 305 regarding the order. For example, the communication interface of the online system may enable exchange of instant messages (e.g., text messages, multimedia messages) between the shopper and the user. The online system may enable the instant messaging functionality from within the application of the online system on the client devices of the user 300 and the shopper 305 such that personally identifiable information (e.g., phone number) of the shopper and/or user is not revealed to each other.

While shopping for the order, the shopper 305 may identify an item to be out of stock and may suggest a replacement to the user. The user 300 may also decide to add additional items or change item quantities or weights for products included in the order. The shopper 305 and the user 300 may communicate these changes or replacements relating to the order via the communication interface on their respective client devices. For example, the user 300 may send a text message describing an item to add to the cart along with a picture of a particular variation of product they want the shopper to add to cart (e.g., a low-sodium variant of a particular brand/size of Taco seasoning). The exchanged messages between the user 300 and the shopper 305 may be stored as a chat log in the data store 380.

While shopping for the order, the application of the online system running on the client device of the shopper 305 may require the shopper 305 to scan (e.g., scan a barcode using the camera function of the client device) each item as it is added to cart for fulfilling the user's 300 order. The anomaly detection module 330 may compare the item picked by the shopper (e.g., as detected by the scanned barcode, based on selection of an item and related parameters like quantity or weight from an item catalog by the shopper, and the like) with products included in the user's 300 order.

For example, the anomaly detection module 330 may detect an anomaly in response to determining that an item picked by the shopper 305 (e.g., red seedless grapes, organic; a specific SKU detected by scanning a barcode on a product) for fulfilling the user's order does not match any item included in the user's 300 order (e.g., a list of SKUs of the order). As another example, the anomaly detection module 330 may detect the anomaly in response to determining that a quantity or weight of an item picked by the shopper 305 (e.g., a specific SKU detected by scanning a barcode on a product, a number of scans for the same barcode, quantity or weight information entered by the shopper, etc.) for fulfilling the user's 300 order does not match an ordered quantity or an ordered weight of an associated item included in the user's order. The anomaly detection module 330 may access order data of the user's 300 order which may be stored in the data store 380.

In one or more embodiments, the anomaly detection module 330 may be configured to not detect an anomaly if the item selection is a threshold match to the associated product in the user's 300 order. For example, if the user's 300 order includes 3 pounds of Organic Gala apples, but the item selection detected by the anomaly detection module (e.g., based on input by the shopper into the client device, based on barcode scan, and the like) indicates that the shopper picked 3.2 pounds of the Organic Gala apples, the anomaly detection module 330 may include logic that considers this to be a match and does not flag this as an anomaly. However, if the shopper were to pick 4 pounds of the Organic Gala apples, the logic of the anomaly detection module 330 may flag this discrepancy as an anomaly. The rules for flagging anomalies may be based on the item, item category, user, order history, and the like. In one or more embodiments, the anomaly detection module 330 may include a machine-learned model that is trained to detect whether a particular instance of a mismatch between an item selection (e.g., a picked item, item quantity, item weight) and an associated product (e.g., specific SKU, approved replacement SKU, quantity, weight, etc.) qualifies as a flaggable anomaly.

The prompt generation module 340 may generate a prompt for execution by a machine-learned model 310. The machine-learned model 310 may be trained as a large language model on a large corpus of training data to perform natural language processing tasks. In one or more embodiments, the machine-learned model 310 may be hosted and trained by a separate entity from the entity responsible for the online system 140. In another embodiment, the machine-learned model 310 may be stored in the data store 380 and parameters of the machine-learned model 310 may be trained (e.g., by the training module 230 FIG. 2) or further fine-tuned based on data specific to the online system 140 stored in the data store 380 and/or the data store 240. As an example, the machine-learned model 310 may be a pre-trained transformer language model and the training module of the online system 140 may further fine tune the parameters of the transformer model using training data (e.g., historical chat log data of all chat logs between shoppers and users, user-level feature data, item-level feature data) stored in the data store 380.

The machine-learned model 310 may be a commercially available large language model, or may be a proprietary model. After the initial training of the model 310, the model 310 may be retrained and updated based on user retention rates, satisfaction rates, as well as user feedback when using the model 310 to automatically adjust guardrails in the shoppers checkout workflow. For example, if the model 310 determines that an item quantity or weight discrepancy is likely acceptable to the user, but the user feedback after receiving the order indicates otherwise, the model may be updated to make the association weaker between the discrepancy and what is deemed acceptable to the user. In one or more embodiments, sentiment analysis of user feedback may be used to update the model 310. The user feedback may be stored as user feedback data in the data store 380.

The training data that may be stored in the data store 380 and that may be used to train or fine-tune the machine-learned model 310 may include a combination of datapoints at the customer or user-level, the product or item-level, and historic database of previous chat logs. For example, data used in the training examples may include historical chat logs between users and shoppers. As another example, data used in the training examples may include user-level features including at least one of the user's prior replacement approval rate (e.g., whether the user is likely is accept an auto-picked replacement); absolute order volume for an item associated with the item selection (e.g., how many times has the user ordered the item detected with the anomaly); use of replacement policy specification at a store front (e.g., likelihood of the user coming back with the anomalous item to the store for a refund or replacement); historic satisfaction with replacements; historic propensity to change item quantities or weights (e.g., likelihood of the user changing item quantities or weights after placing the order and before or during the order is being shopped by the shopper at the retailer); historic propensity to add incremental items to an order, and the like.

As another example, data used in the training examples may include item-level features including at least one of historic chats mapped to orders including an item associated with the item selection (e.g., what happened in other orders where the same item selection anomaly was delivered to the customer without their prior approval); historic replacement rates associated with an item associated with the item selection; historic likelihood to experience quantity adjustments for an item associated with the item selection (e.g., how often does the item associated with the anomaly has its quantity or weight adjusted by users after the initial order placement).

The prompt generated by the prompt generation module 340 may include at least the chat log between the user 300 and the picker 305. The chat log may be stored in and accessed by the prompt generation module 340 from the data store 380 as order data associated with the current order of the user 300. The prompt generation module 340 (and/or the model serving system 150) may provide the generated prompt to the machine-learned model 310 for execution.

In one or more embodiments, the prompt generated by the prompt generation module 340 for execution by the machine-learned model may include additional data other than the chat log of the messages (e.g., text messages, images, videos, etc.) exchanged between the shopper 305 and the user 300. For example, the additional data included in the prompt may include order data associated with the user's order. The order data may be stored in and accessed by the prompt generation module 340 from the data store 380 and may represent the order placed by the user 300. For example, the order data may indicate a list of products (e.g., SKUs, product identifier) and associated information for each ordered product (e.g., quantity, weight, size, etc.). In one or more embodiments, instead of inputting the entire list of products included the order, the prompt generation module 340 may extract one or more products from the order that are associated with the anomalous item selection as detected by the anomaly detection module 330. For example, if the order includes a 1 pack of a particular brand of noodles, and the item selection by the picker as detected by the anomaly detection module 330 indicates the shopper has picked 2 packs of that particular brand of noodles, the prompt generation module 340 may extract information regarding the particular brand of noodles and ordered quantity (or weight) and include it in the prompt, instead of including information regarding the whole order.

That is, the prompt generation module 340 may generate a prompt for the model serving system 150 to analyze chat logs between the shopper 305 and the user 300 to determine whether the discrepancy was initiated or approved or discussed with the user 300 associated with the order. The prompt to the model 310 may request a determination of whether the identified anomaly can be attributed to contents of the chat log. The prompt to the model serving system 150 may include information pertinent to the order item (i.e., the originally ordered amount) along with the chat logs, especially in embodiments where the anomaly may be related to weight or quantity of an item.

In response to the prompt generated by the prompt generation module 340 being input to the model 310, the model 310 may generate an output. The output from the machine-learned model 310 may be in any modality, e.g., text, image, audio, video, and the like. In one or more embodiments, based on at least the chat log between the user 300 and the shopper 305 included in the prompt input to the model 310, the machine-learned model 310 may output a description indicating whether the anomaly detected by the anomaly detection module 330 is attributable to the user 300. For example, the description output from the model 310 may indicate whether the item selection anomaly detected by the anomaly detection module 330 is a discrepancy that may be acceptable to the user.

For example, prompts input to the model 310 (e.g., LLM) may include the following.

```
Prompt → “Given the following exchange between a customer and a
shopper:
  [
  {‘12:00:10’, ‘Shopper’, ‘Looks like they are out of organic
grapes} ,
  {‘12:01:02’, ‘Customer’, ‘If there aren't any organic, then non-
organic is fine’} ,
  {‘12:02:09’, ‘Shopper’, ‘Will do!’}
  ],
Are any of the following products being discussed <‘Dole Grapes’,
Bounty Paper Towels’,‘Fruit Roll-Ups'>?”
```

In response to the above input, the model 310 may provide an output. The output may be a description of whether the potential anomaly is attributed to the user. For example, the output from the model serving system 150 may include “Seems like the conversation included a discussion on Dole Grapes”.

In one or more embodiments, the output from the model 310 or the model serving system 150 may be a description that indicates an updated estimate of an ordered amount (e.g., quantity, weight) of a product included in the user's 300 order and determined to be associated with the item selection detected as being an anomaly by the module 330. For example, prompt input to the model 310 (e.g., LLM) may include the following.

```
Prompt → “The customer originally ordered 1 box of <noodles> at
<12:19:02’> but I know the customer and the shopper exchanged the
following texts after that:
  [
  {‘15:23:07’, ‘Customer’, ‘can you add another box of noodles to me
order?’},
  {‘15:24:10’, ‘Shopper’, ‘certainly’}
  ]
How many boxes of <noodles> does the customer need?”
```

In response to the above input, the model 310 or the model serving system 150 may provide an output including a description. The description may include an identification of the item and/or the updated estimate of the quantity or weight of the item likely ordered by the user (i.e., the user's intent). For example, output from the model serving system 150 may include “Seems like the customer would like 2 boxes of noodles”.

In one or more embodiments, the description output from the model serving system 150 based on the output of the model 310 may be based on additional data other than the chat log data. For example, as explained previously, the model 310 may be trained on the user-level features and/or the product-level features. Also, in one or more embodiments, the prompt input to the model may include additional context information (e.g., historical data associated with the user, historical data associated with the item at issue, etc.). The model 310 may thus be able to determine the user's intent or what may be acceptable to the user based on data beyond the chat log between the user and shopper for the current order.

For example, the output description may indicate (e.g., based on the user's order history) whether an anomalous item selection may be attributable or acceptable to the user 300 even if the chat log does not indicate that the item can be attributed to the user. As another example, the output description may indicate (e.g., based on the user's order history) whether an anomalous item amount (e.g., quantity, weight) may be attributable or acceptable to the user 300 even if the chat log does not indicate that the item amount can be attributed to the user.

The determination module 350 may determine, based on the output from the machine-learned model 310, that the anomalous item selection detected by the anomaly detection module 330 is not attributable to the user. For example, if the description output from the LLM indicates that the chat log does not refer to an item detected as an anomaly, the determination module 350 may determine that the anomaly item is not attributable to the user. As another example, if the description output of the LLM indicates that the chat log does not refer to an anomaly item and the description further indicates that inclusion of this anomalous particular item in the order delivery to this particular user without prior approval from the user is likely going to be unacceptable to this particular user, the determination module 350 may determine that the anomaly item is not attributable to the user.

As another example, if, based on the original order data, and further based on the chat log and/or contextual information associated with this particular user and/or this particular item, the description output from the LLM indicates a particular estimated ordered quantity or weight for the item, the determination module 350 may determine that the item amount discrepancy is not attributable to the user if the item quantity or weight picked by the shopper does not match (or be within a tolerance threshold of) the particular estimated quantity or weight of the ordered item as described in the LLM output.

Responsive to the determination module 350 determining that the item selection is not attributable to the user 300 based on the output from the model serving system 150, the notification module 360 provides a notification to a client device of the user 300 to confirm whether the item selection is approved by the user 300. In one or more embodiments, the notification module 360 may in this situation also provide another notification to a client device of the shopper that payment for the item selection is on hold pending approval from the user 300. In this manner, when the modification cannot be attributed to the user of the order, the notification module 360 can send notifications to the user 300 of the order to confirm whether the user 300 approves of the modification before preventing the shopper 305 from proceeding with the modification.

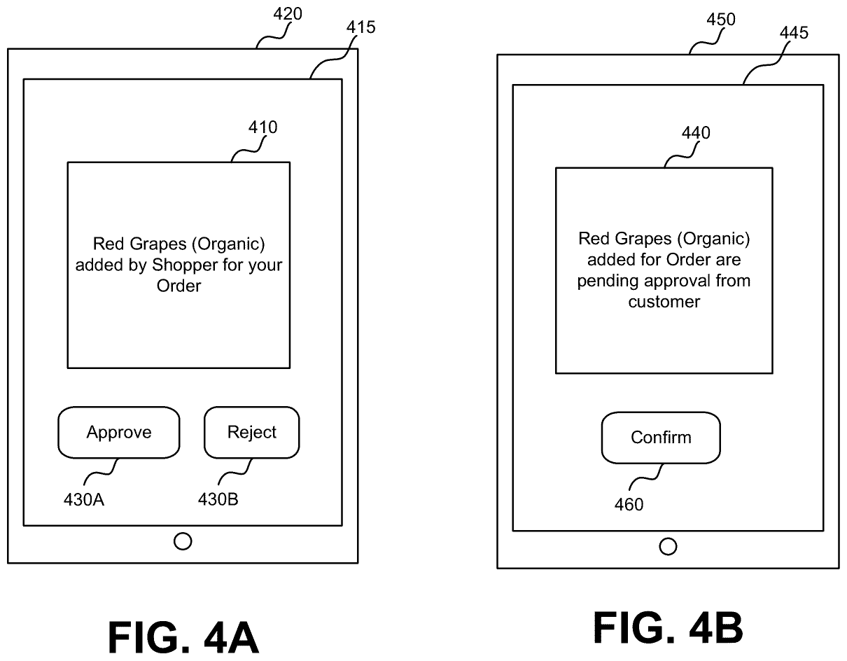

In one or more embodiments, the notification provided by the notification module 360 to the client device of the user 300 and/or the client device of the shopper 305 may be a push notification, a pop-up notification, a text message, an instant message, an email, an automated phone call, or any other appropriate notification. The operation of the notification module 360 is described in further detail below in connection with FIGS. 4A-4B.

FIG. 4A illustrates an example notification 410 to a client device 420 of a user (e.g., user 300 of FIG. 3) of an online system, in accordance with one or more embodiments. FIG. 4A illustrates that the application of the online system running on the client device 420 of the user presents a push or popup notification 410 in a user interface 415 describing the anomaly for which the determination module 350 has determined that the item selection is not attributable to the user. FIG. 4A illustrates a situation where the original order placed by the user with the online system did not include red organic grapes. However, the shopper that is fulfilling this order for the user picked the organic red grapes and added them to the user's cart by, e.g., scanning a barcode or taking an image with a camera of the client device of the shopper. As a result, the anomaly detection module 330 detects this item selection (e.g., scanning the barcode for the red organic grapes) as an anomaly and the prompt generation module 340 causes the machine-learned model 310 to analyze the chat logs and/or contextual information to output a description indicating whether the item selection is attributable to the user. If, e.g., the chat logs make no mention of the user asking the shopper to add these grapes to cart, the description from the LLM would convey this, and the determination module 350 will determine that the selection is not attributable to the user. As a result, the notification module 360 provides or transmits the push notification 410 to the user's client device to obtain express approval of the user before this item selection by the shopper can be approved and the shopper can be allowed to checkout or make the payment for the item at checkout. The notification module 360 may further provide the user with interactive elements 430A, 430B on the user interface 415. The user may interact with the interactive elements 430A, 430B to either approve 430A the anomalous item selection by the shopper, or reject 430B the item selection, thereby forcing the shopper to remove this item from the cart.

FIG. 4B illustrates an example notification 440 to a client device 450 of a shopper (e.g., shopper 305 of FIG. 3) of an online system, in accordance with one or more embodiments. FIG. 4B illustrates that the application of the online system running on the client device 450 of the shopper presents a push or popup notification 440 in a user interface 445 describing the anomaly for which the determination module 350 has determined that the item selection is not attributable to the user. The notification module 360 provides or transmits the push notification 440 to the shopper's client device to indicate that the red organic grapes have been detected as an anomaly and that payment for this item selection is on hold pending approval from the customer.

The notification module 360 may further provide the shopper with an interactive element 460 on the user interface 445 prompting the shopper to confirm the on-hold status for this item picked and added to cart by the shopper for the order. For example, this interaction may prompt the shopper to initiate a communication via the communication interface with the user to confirm whether they would like to approve this item selection.

In one or more embodiments, responsive to determining that the customer did not approve a change that is detected in the order, the shopper receives a notification that the order is paused pending approval by the customer. In one or more embodiments, the shopper may be prompted to further communicate with the customer or provide further clarification regarding the detected change or discrepancy. In one or more embodiments, the shopper may have already received approval which was not detected, and the shopper may provide the additional information to the online system 140.

In instances where the discrepancy is related to an item amount (e.g., quantity, weight) and the description from the LLM indicates the anomaly is not attributable to the user, the notification module 360 may similarly provide notifications to the client devices 420 and 450 asking the user to expressly approve the change in quantity or weight of the item, and warning the shopper that the added item quantity or weight can be checked out only with express approval from the user. That is, in response to the determination module 350 determining that the quantity or weight of the item picked by the shopper does not match (within a tolerance threshold) the updated estimate of the ordered quantity or the ordered weight of the associated product (based on the output from the LLM) included in the user's order, the notification module 360 provides a notification to the client device 420 of the user to confirm whether the selected item quantity, amount, or weight is approved by the user. The notification module 360 may further provide a notification to the client device 450 of the shopper indicating that payment for the selected item quantity, amount, or weight is on hold pending approval from the user.

The blocking module 370 may provide an additional guardrail in the shopper workflow to prevent unnecessary notifications to the client device of the user for approval of changes that are likely going to be rejected by the user. That is, the blocking module 370 may determine whether the quantity or weight of the item picked by the shopper for fulfilling the user's order differs by more than a blocking threshold from the updated estimate of the ordered quantity or the ordered weight of the associated product included in the user's order. And responsive to the blocking module 370 determining that the quantity or weight of the item picked by the shopper differs by more than the blocking threshold, the blocking module 370 may block the item selection made by the shopper without prompting the client device of the user for approval. The notification module 360 in this instance may present a popup notification on the client device of the shopper indicating this block without also providing any notifications to the client device of the user. For example, if the user has ordered 1 box of noodles and the picker has picked and added 10 boxes to cart, and if there is nothing in the chat or context information indicating this change is attributable to the user or that it may be acceptable to the user, the blocking module 370 may automatically block this action of the shopper and prevent the shopper from checking out, thereby forcing the picker to pick a lower quantity or obtain express approval from the user to make a more significant change to an order. As another example, based on an output from the model serving system 150, the blocking module 370 may determine a confidence score indicating a level of confidence in a determination that the modification or the item selection is not attributable to the user 300. If the confidence score is higher than a threshold, the blocking module 370 may automatically block the item selection of the shopper and prevent the shopper from checking out without making a change to the item selection. Thus, if the shopper added an unrelated item to cart and there is no indication in the chat or context information that the unrelated item is attributable to the user, the blocking module 370 may automatically block the item without prompt the user for approval on adding the unrelated item to cart.

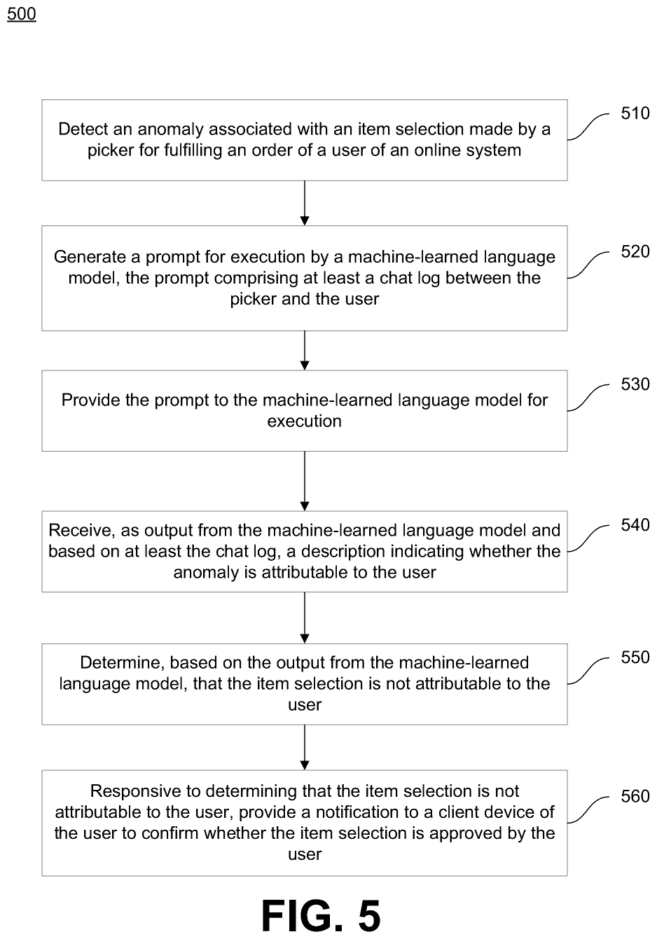

FIG. 5 is a flowchart for a method 500 of modifying workflow guardrails for order fulfillment on an online system, in accordance with one or more embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention. The anomaly detection module 330 may detect 510 an anomaly associated with an item selection made by a shopper for fulfilling an order of a user of an online system. For example, the anomaly may indicate an item added to cart which has no corresponding product in the user's order. As another example, the anomaly may represent a discrepancy in the amount of an ordered item. The prompt generation module 340 may generate 520 a prompt for execution by a machine-learned model (e.g., model 310 in FIG. 3) trained as a large language model on a large corpus of training data to perform natural language processing tasks, the prompt comprising at least a chat log between the shopper and the user. The model serving system 150 may provide 530 the prompt to the machine-learned model for execution. The workflow guardrails module 225 may receive 540, as output from the machine-learned model and based on at least the chat log, a description indicating whether the anomaly is attributable to the user. The determination module 350 may determine 550, based on the output from the machine-learned model 310, that the item selection is not attributable to the user. Responsive to determining that the item selection is not attributable to the user, the notification module 360 may provide 560 a notification (e.g., FIG. 4A) to a client device of the user to confirm whether the item selection is approved by the user.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In one or more embodiments, a software module is implemented with a computer program product comprising one or more computer-readable media storing computer program code or instructions, which can be executed by a computer processor for performing any or all of the steps, operations, or processes described. In one or more embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
detecting an anomaly associated with an item selection made by a picker for fulfilling an order of a user of an online system;
in response to detecting the anomaly, generating a prompt for execution by a machine-learned language model, the prompt comprising at least a chat log between the picker and the user;
providing the prompt to the machine-learned language model for execution;
receiving, as output from the machine-learned language model and based on at least the chat log, a description indicating whether the anomaly is attributable to the user;
identifying, based on the output from the machine-learned language model, that the item selection is not attributable to the user; and
performing an automated action responsive to identifying that the item selection is not attributable to the user.

2. The method of claim 1, wherein performing the automated action comprises at least one of:
causing a client device of the user to display a notification to confirm whether the item selection is approved by the user; and
providing another notification to a client device of the picker indicating that payment for the item selection is on hold pending approval of the user.

3. The method of claim 2, further comprising:
determining a confidence score associated with the indication of the item selection as being not attributable to the user; and
responsive to the confidence score being higher than a threshold, blocking the item selection made by the picker without prompting the user for approval.

4. The method of claim 2, wherein detecting the anomaly associated with the item selection comprises:
identifying that a quantity or weight of an item picked by the picker for fulfilling the user's order does not match an ordered quantity or an ordered weight of an associated item included in the user's order.

5. The method of claim 4, wherein the description received as the output from the machine-learned language model based on the chat log indicates an updated estimate of the ordered quantity or the ordered weight of the associated item included in the user's order.

6. The method of claim 5, wherein the notification is provided to the client device of the user to confirm whether the item selection is approved by the user in response to determining that the quantity or weight of the item picked by the picker does not match the updated estimate of the ordered quantity or the ordered weight of the associated item included in the user's order.

7. The method of claim 5, further comprising:
identifying whether the quantity or weight of the item picked by the picker for fulfilling the user's order differs by more than a blocking threshold from the updated estimate of the ordered quantity or the ordered weight of the associated item included in the user's order; and
responsive to identifying that the quantity or weight of the item picked by the picker differs by more than the blocking threshold, blocking the item selection made by the picker without prompting the client device of the user for approval.

8. The method of claim 1, further comprising:
receiving an indication that the user interacted with a user interface (UI) element on a client device of the user to approve the item selection; and
responsive to receiving the indication, approving payment for the item selection for the order.

9. The method of claim 1, wherein detecting the anomaly associated with the item selection comprises:
identifying that an item picked by the picker for fulfilling the user's order does not match an item included in the user's order.

10. The method of claim 1, wherein the prompt generated for execution by the machine-learned language model further comprises order data associated with the user's order.

11. The method of claim 1, wherein the machine-learned language model is trained on historic chat logs between pickers and users.

12. The method of claim 1, wherein the machine-learned language model is trained on user-level features including at least one of the user's:
prior replacement approval rate;
absolute order volume for an item associated with the item selection;
use of replacement policy specification at a store front;
historic satisfaction with replacements;
historic propensity to change item quantities or weights; or
historic propensity to add incremental items to an order.

13. The method of claim 1, wherein the machine-learned language model is trained on item-level features including at least one of:
historic chats mapped to orders including an item associated with the item selection;
historic replacement rates associated with an item associated with the item selection; or
historic likelihood to experience quantity adjustments for an item associated with the item selection.

14. The method of claim 1, further comprising:
receiving feedback from the user indicating whether the description output from the machine-learned language model is accurate; and
training the machine-learned language model based on the feedback from the user.

15. A non-transitory computer-readable storage medium storing instructions that, when executed by a computer processor, cause the computer processor to perform operations comprising:
detecting an anomaly associated with an item selection made by a picker for fulfilling an order of a user of an online system;
in response to detecting the anomaly, generating a prompt for execution by a machine-learned language model, the prompt comprising at least a chat log between the picker and the user;
providing the prompt to the machine-learned language model for execution;
receiving, as output from the machine-learned language model and based on at least the chat log, a description indicating whether the anomaly is attributable to the user;
identifying, based on the output from the machine-learned language model, that the item selection is not attributable to the user; and
performing an automated action responsive to identifying that the item selection is not attributable to the user.

16. The non-transitory computer-readable storage medium of claim 15, wherein performing the automated action comprises at least one of:
causing a client device of the user to display a notification to confirm whether the item selection is approved by the user; and
providing another notification to a client device of the picker indicating that payment for the item selection is on hold pending approval of the user.

17. The non-transitory computer-readable storage medium of claim 16, the operations further comprising:
receiving an indication that the user interacted with a user interface (UI) element on the client device of the user to approve the item selection; and
responsive to receiving the indication, approving payment for the item selection for the order.

18. The non-transitory computer-readable storage medium of claim 15, wherein detecting the anomaly associated with the item selection comprises:
identifying that an item picked by the picker for fulfilling the user's order does not match an item included in the user's order.

19. The non-transitory computer-readable storage medium of claim 15, wherein the prompt generated for execution by the machine-learned language model further comprises order data associated with the user's order.

20. A system comprising:
a computer processor; and
a non-transitory computer-readable storage medium storing instructions that, when executed by the computer processor, cause the computer processor to perform operations comprising;
detecting an anomaly associated with an item selection made by a picker for fulfilling an order of a user of an online system;
in response to detecting the anomaly, generating a prompt for execution by a machine-learned language model, the prompt comprising at least a chat log between the picker and the user;
providing the prompt to the machine-learned language model for execution;
receiving, as output from the machine-learned language model and based on at least the chat log, a description indicating whether the anomaly is attributable to the user;
identifying, based on the output from the machine-learned language model, that the item selection is not attributable to the user; and
performing an automated action responsive to identifying that the item selection is not attributable to the user.
